(19) United States
(12) Patent Application Publication
(10) Pub. No.: US 2024/0070562 A1
(43) Pub. Date: Feb. 29, 2024

(54) INFORMATION PROCESSING SYSTEM, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventors: Tomotake NIHIRA, Kanagawa (JP); Miku Enomoto, Kanagawa (JP); Momoko Fujiwara, Tokyo (JP); Kengo Tokuchi, Kanagawa (JP)

(73) Assignee: FUJIFILM Business Innovation Corp., Tokyo (JP)

(21) Appl. No.: 18/178,674

(22) Filed: Mar. 6, 2023

(30) Foreign Application Priority Data
Aug. 31, 2022 (JP) 2022-137967

(51) Int. Cl. G06Q 10/02; G06Q 10/1093

(52) U.S. Cl. CPC G06Q 10/025; G06Q 10/1095

(57) ABSTRACT

An information processing system includes one or more processors configured to: acquire, from a client expected to use plural reservable services in combination, client information including a purpose of the client; identify the plural services associated with the purpose in the client information; acquire business operator information on business operators that provide the plural identified services, the business operator information including schedules of the business operators; and make a collective reservation for a combination of the plural identified services with use time frames of the plural services not overlapping each other based on the business operator information.

### CROSS-REFERENCE TO RELATED APPLICATIONS

This application is based on and claims priority under 35 USC 119 from Japanese Patent Application No. 2022-137967 filed Aug. 31, 2022.

### BACKGROUND

### (i) Technical Field

The present disclosure relates to an information processing system, a non-transitory computer readable medium storing a program, and an information processing method.

### (ii) Related Art

Japanese Patent No. 6928409 describes a schedule adjustment apparatus that, in response to an input from an adjustment starting person for a meeting in which a plurality of persons are expected to participate, sets an adjustment condition including a plurality of items for meeting schedule adjustment and issues access information to a schedule adjustment screen. Japanese Patent No. 6928409 discloses that third candidate schedules are extracted in response to an input from an intermediate inputting person who has accessed the schedule adjustment screen and fourth candidate schedules are extracted from the third candidate schedules in response to an input from a final inputting person who has accessed the schedule adjustment screen.

### SUMMARY

Aspects of non-limiting embodiments of the present disclosure relate to the following circumstances. For example, a client may make a reservation for a desired service by specifying the service and a time frame for use of the service. The same may apply to a case where reservations are made for a plurality of services. In this case, the client makes the reservations by specifying the services and time frames for use of the services.

Aspects of non-limiting embodiments of the present disclosure therefore relate to improvement in usability of the client who is going to make reservations for a plurality of services compared with a case where reservations are made by specifying a plurality of services and time frames for use of the services.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system comprising one or more processors configured to: acquire, from a client expected to use a plurality of reservable services in combination, client information including a purpose of the client; identify the plurality of services associated with the purpose in the client information; acquire business operator information on business operators that provide the plurality of identified services, the business operator information including schedules of the business operators; and make a collective reservation for a combination of the plurality of identified services with use time frames of the plurality of services not overlapping each other based on the business operator information.

### BRIEF DESCRIPTION OF THE DRAWINGS

Exemplary embodiments of the present disclosure will be described in detail based on the following figures, wherein:

FIG. 1 illustrates a collective reservation system that makes a collective reservation for a plurality of services according to a first exemplary embodiment;

FIG. 2 illustrates an example of the overall configuration of an information processing system according to the first exemplary embodiment;

FIG. 3 illustrates an example of the external configuration of a booth space;

FIG. 4 illustrates an example of the hardware configuration of a terminal apparatus for use in the first exemplary embodiment;

FIG. 5 illustrates an example of the functional configuration of a client's terminal according to the first exemplary embodiment;

FIG. 6 illustrates an example of the hardware configuration of a management server for use in the first exemplary embodiment;

FIG. 7 illustrates an example of the functional configuration of a reservation management server according to the first exemplary embodiment;

FIG. 8 illustrates an example of service information based on a purpose of a client;

FIGS. 9A and 9B illustrate extraction of reservation candidates, in which FIG. 9A illustrates an examining sequence on combinations of a plurality of services associated with the purpose of the client and FIG. 9B illustrates extracted reservation candidates;

FIG. 10 is a flowchart illustrating a flow of a process for making a collective reservation for a plurality of services associated with the purpose of the client by the reservation management server of the first exemplary embodiment;

FIG. 11 illustrates an example of service information stored in a service information DB;

FIGS. 12A and 12B illustrate examples of schedules of business operators stored in a business operator schedule DB, in which FIG. 12A illustrates a schedule of a real estate company A and FIG. 12B illustrates a schedule of a real estate company B;

FIGS. 13A and 13B illustrate examples of reservation statuses of places stored in a place information DB, in which FIG. 13A illustrates a reservation status of a booth A and FIG. 13B illustrates a reservation status of a booth B;

FIG. 14 illustrates an example of a reservation screen for receiving a reservation for services;

FIG. 15 is a flowchart illustrating a flow of a process for making a collective reservation for a plurality of services associated with a purpose of the client and a filtering condition by the reservation management server of the first exemplary embodiment;

FIG. 16 illustrates an example of service information stored in the service information DB;

FIG. 17 illustrates extraction of reservation candidates based on schedules of business operators;

FIG. 18 illustrates another example of the reservation screen for receiving a reservation for services;

FIG. 19 illustrates another example of the reservation screen for receiving a reservation for services;

FIG. 20 illustrates another example of the reservation screen for receiving a reservation for services;

FIG. 21 illustrates another example of the reservation screen for receiving a reservation for services;

FIG. 22 is a flowchart illustrating a flow of a process for recombining a plurality of collectively reserved services by the reservation management server of the first exemplary embodiment;

FIG. 23 is a flowchart illustrating a flow of a process for recombining a plurality of services by calling for a business operator by the reservation management server of the first exemplary embodiment; and

FIG. 24 illustrates an example of the overall configuration of an information processing system according to a second exemplary embodiment.

### DETAILED DESCRIPTION

Exemplary embodiments of the present disclosure are described with reference to the accompanying drawings.

### First Exemplary Embodiment

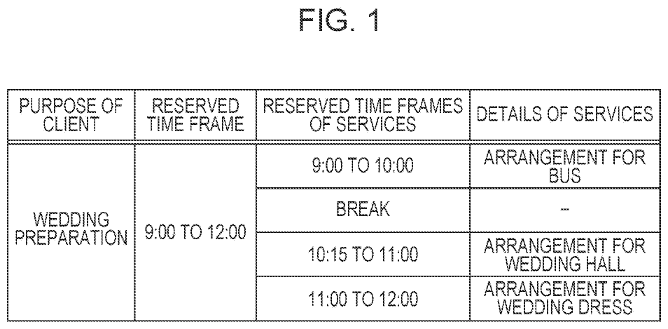

FIG. 1 illustrates a collective reservation system that makes a collective reservation for a plurality of services according to a first exemplary embodiment.

The collective reservation system presents a combination of a plurality of services associated with a purpose of a client with their use time frames not overlapping each other, and receives a collective reservation for the use of the plurality of services in the combination.

In this exemplary embodiment, the “service” is a so-called interpersonal service to be provided directly from person to person. The “service” may be provided to a client face to face or via a web.

In the example illustrated in FIG. 1, the purpose of the client is “wedding preparation” and an expected reserved time frame of the services is “9:00-12:00”. In the collective reservation system, the services are identified as arrangement for a bus, arrangement for a wedding hall, and arrangement for a wedding dress for the purpose “wedding preparation”. Information is generated to indicate candidates for reservation for a combination of the identified services in the reserved time frame with their use time frames not overlapping each other (hereinafter referred to as “reservation candidates”). A screen for receiving a collective reservation for the services is presented to the client based on the information.

The collective reservation system receives a collective reservation for the use of services provided by various business operators. If the business operator of the reserved service changes or the reserved time frame is long, a break may be provided between the reserved time frames of the services.

### [Information Processing System 1]

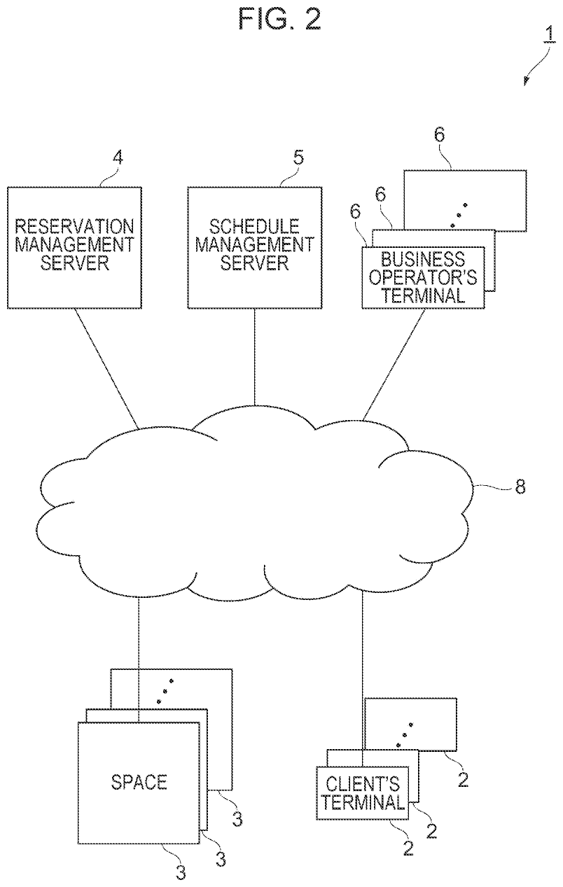

FIG. 2 illustrates an example of the overall configuration of an information processing system 1 according to the first exemplary embodiment.

The information processing system 1 of this exemplary embodiment implements the collective reservation system that makes a collective reservation for a plurality of services.

As illustrated in FIG. 2, the information processing system 1 includes client's terminals 2, a plurality of spaces 3, a reservation management server 4, a schedule management server 5, and business operator's terminals 6. In the information processing system 1, the client's terminals 2, the spaces 3, the reservation management server 4, the schedule management server 5, and the business operator's terminals 6 may mutually communicate information via a communication network 8. In this exemplary embodiment, the communication network 8 is not particularly limited as long as information may be communicated among the apparatuses. Examples of the communication network 8 include the Internet.

In this exemplary embodiment, the client's terminal 2 is a terminal apparatus to be used by a client to make a reservation for the space 3 and a service provided by a business operator. The client's terminal 2 is a terminal apparatus owned by the client.

Examples of the client's terminal 2 of this exemplary embodiment include a computer, a tablet information terminal, a smartphone, a wearable terminal, and a gaming terminal.

In this exemplary embodiment, the space 3 is provided by the information processing system 1 and is a part of a shared facility available to the client. The space 3 is a rental place for the use of services of business operators. The space 3 includes various devices connected to the communication network 8.

In this exemplary embodiment, the plurality of spaces 3 are provided as examples of the place to be reserved by the client. In this exemplary embodiment, each space 3 is reservable and the client may use the space 3 by making a reservation for the space 3.

Examples of the space 3 include a booth, a meeting room, and a room of an accommodation. These are examples of the space 3 demarcated from surroundings with walls, partitions, or the like.

Examples of the space 3 of this exemplary embodiment include a table and a seat in a restaurant or a barber shop where services are provided. These are examples of the space 3 open to surroundings.

The number of business operators that manage the spaces 3 may be one or plural.

For example, different business operators may individually have responsibilities for management of reservations, management of entry/exit and usage of rooms, management of charges for use on clients, and management of members registered as clients. The spaces 3 to be managed for reservation need not be the same type of space. For example, a subset of the spaces 3 may be booths and another subset of the spaces 3 may be seats in restaurants. A plurality of business operators may offer management of one purpose or function in cooperation.

In this exemplary embodiment, the reservation management server 4 manages various types of information on spaces 3. The reservation management server 4 also manages information on services of business operators.

The reservation management server 4 includes an information database (DB). The information DB is implemented by an information recording device such as a secondary storage 42 described later. The information DB stores various types of information such as information on reservations for spaces 3, information indicating internal conditions of spaces 3, information on categories of business operators based on purposes of clients, and information on schedules of business operators.

For example, the reservation management server 4 manages information on reserved spaces 3, information on clients, information on business operators that provide services associated with purposes of clients, and start times and end times of reservations.

Examples of the information on a space 3 as an example of place information include information for identifying the space 3 and information on a schedule of the space 3. Examples of the information for identifying the space 3 include information for identifying an address or a location, a management name, and a management number.

Examples of the information on a client as an example of client information include information indicating a purpose of a client expected to use a plurality of reservable services in combination. Examples of the information on a client include information for identifying the client typified by a name, sex, age, account, user ID, password, and personal management information of the client.

Examples of the information on a client may include information indicating a place for use of a plurality of services associated with the purpose of the client. Specifically, the information on the client may include information for identifying a space 3 to be used by the client among the plurality of spaces 3.

Examples of the information on a business operator as an example of business operator information include information for identifying a service associated with the purpose of a client among services provided by the business operators. Examples of the information for identifying a service associated with the purpose of a client include a service category based on the purpose, a business operator name of the service, an expected period of the service, and a feature of the service of the business operator.

Examples of the information on a business operator include a schedule of the business operator that provides a service associated with the purpose of a client. Examples of the schedule of the business operator include information indicating business hours of the business operator and information on reservation for a service of the business operator. The schedule of the business operator is provided from the schedule management server 5 to the reservation management server 4. For example, the reservation management server 4 and the schedule management server 5 operate in conjunction with each other by using an application programming interface (API) provided by the reservation management server 4 and the schedule management server 5.

The reservation management server 4 functions also as a control device to control various devices installed in the spaces 3. The control device may be installed in each space 3. In this case, the control device installed in each space 3 controls various devices installed in the spaces 3.

In this exemplary embodiment, the schedule management server 5 manages schedules of business operators that provide services.

The schedule management server 5 includes an information DB. The information DB is implemented by an information recording device. The information DB stores various types of information such as information indicating business hours of business operators and information on reservations for services of business operators.

For example, the reservation management server 4 and the schedule management server 5 are implemented by server machines such as computers, but the number of server machines is not limited. For example, the reservation management server 4 and the schedule management server 5 may be distributed to a plurality of virtual server machines in a so-called cloud environment to implement the functions of the management servers.

In this exemplary embodiment, the business operator's terminal 6 is a terminal apparatus to be used by a business operator that provides a service.

Examples of the business operator's terminal 6 of this exemplary embodiment include a computer, a tablet information terminal, a smartphone, a wearable terminal, and a gaming terminal.

### [External Configuration of Space 3]

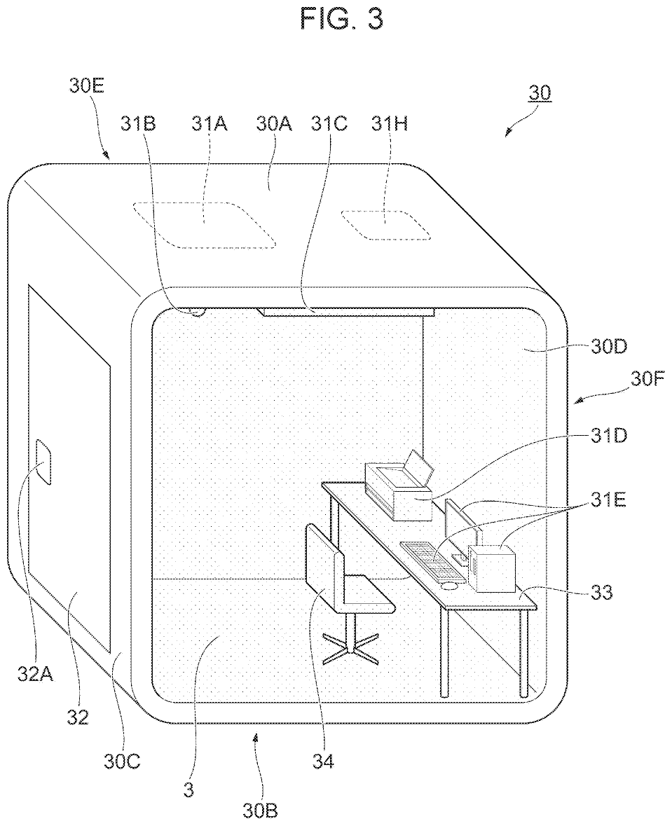

FIG. 3 illustrates an example of the external configuration of a booth space 3.

In the example illustrated in FIG. 3, the space 3 is the inside of a booth 30. In this exemplary embodiment, reservation may be made for the space 3 inside the booth 30.

In this exemplary embodiment, the booth 30 is disposed irrespective of indoors or outdoors. For example, the booth 30 is disposed in a station yard, an airport, an office building, a commercial facility such as a restaurant or a department store, a bank, a library, an art gallery, a museum, a public institution or facility, an accessway, or a park.

In FIG. 3, the booth 30 is a closed booth 30 having a ceiling.

The term “closed” does not mean “sealed” and the closed booth has a practical sound-proof property.

The “booth 30” is a structure having partitions between the space 3 and the other space around the space 3. The partitions need not be provided entirely around the space 3 and a structure having no partition in part also corresponds to the booth 30. The ceiling need not be provided and a structure having no ceiling also corresponds to the booth 30.

In this exemplary embodiment, the booth 30 includes a ceiling 30A, a floor 30B, a wall 30C having an openable and closable door 32, two walls 30D and 30E on both sides of the wall 30C, and a wall 30F opposite to the door 32.

In the example illustrated in FIG. 3, the door 32 is a single hinged door having one swingable door member, but may be a double hinged door having one opening closed by two door members.

The door 32 may be a single sliding door that slides in one direction, a double sliding door to be opened or closed by moving two or more members in different directions, a drawn door having two members slidable to right and left, or a folding door.

An authentication unit 32A is provided outside the booth 30 to acquire authentication information of a client who uses the booth 30. Various existing methods may be used as a method for acquiring authentication information by the authentication unit 32A. Various devices are used as the authentication unit 32A depending on the client information acquisition method. Examples of the devices include a card reader that reads an ID card and a sensor that reads biometric information of a client, such as a fingerprint or a vein pattern. As another example, information may be acquired by connection to the client's terminal 2 using wireless communication such as Bluetooth (registered trademark) or near field communication (NFC).

The number of users of the booth 30 is roughly determined depending on the volume of the booth 30. In this exemplary embodiment, the booth 30 is a private room that is basically used alone. The booth 30 may be a large booth 30 capable of accommodating many persons.

The term “private room” does not mean a room exclusive to one person alone, but means a room that may be used by a few persons such as two or three persons.

The shape and structure of the booth 30 that defines the space 3 and the provided equipment and performance thereof are arbitrary.

In this exemplary embodiment, the booth 30 includes one desk 33 and one chair 34. A printer 31D and a terminal apparatus 31E that are examples of devices 31 are disposed on the desk 33. The terminal apparatus 31E is used for using a plurality of services. Examples of the terminal apparatus 31E include a computer. Data and history information stored in the terminal apparatus 31E are completely erased after the use under control of the system to protect client information.

In this exemplary embodiment, the booth 30 as an example of the place is fully equipped with electricity and the Internet to provide an environment to use the terminal apparatus 31E and the like.

In the example illustrated in FIG. 3, the devices 31 include an air conditioner 31A installed in the booth 30, a motion sensor 31B that detects motion of a person in the booth 30, a lighting device 31C that illuminates the booth 30, and a control device 31H that controls operations of electronic devices including the devices 31. The specific electronic devices described as the devices 31 are examples of the electronic devices.

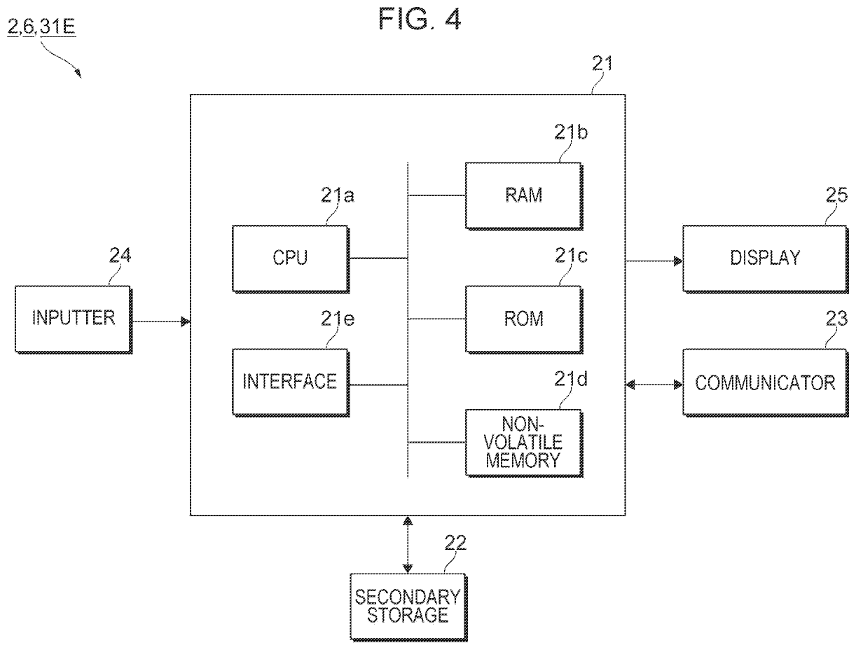

For example, the printer 31D and the terminal apparatus 31E on the desk 33 may be omitted. In this case, the client's terminal apparatus such as a computer or a smartphone is used for using a plurality of services. Business operators that provide the services may visit the booth 30 of the client within use time frames of the services.

[Configuration of Terminal] FIG. 4 illustrates an example of the hardware configuration of each of the client's terminal 2, the business operator's terminal 6, and the terminal apparatus 31E for use in the first exemplary embodiment.

In this exemplary embodiment, the terminal apparatus includes a controller 21 that controls overall operation of the apparatus, a secondary storage 22 that stores information on reservation, and a communicator 23 that transmits and receives information via the communication network 8 (see FIG. 2). The terminal apparatus further includes an inputter 24 such as keys or a touch panel for receiving user's input operations, and a display 25 such as a liquid crystal display panel or an organic electroluminescence (EL) display panel for displaying images and texts for the user.

The controller 21 includes a CPU 21a that controls the entire apparatus as an example of a processor, a RAM 21b to be used as, for example, a working memory for the CPU 21a, and a ROM 21c that stores, for example, programs to be executed by the CPU 21a. The controller 21 further includes a rewritable non-volatile memory 21d that may retain data even in a case of disruption of power supply, and an interface 21e that controls individual parts of the communicator 23 and other components connected to the controller 21.

Examples of the non-volatile memory 21d include an SRAM and a flash memory backed up by a battery. The controller 21 reads the programs stored in the secondary storage 22 to perform processes of the terminal apparatus of this exemplary embodiment.

Examples of the secondary storage 22 include a hard disk drive (HDD) and a semiconductor memory. The secondary storage 22 varies depending on commercial forms of the client's terminal 2, the business operator's terminal 6, and the terminal apparatus 31E. For example, the secondary storage 22 stores programs to be executed by the controller 21 and information on reservation.

Next, the functional configuration of the client's terminal 2 is described.

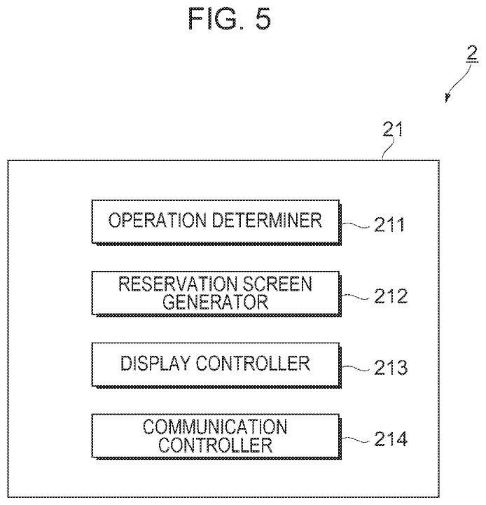

FIG. 5 illustrates an example of the functional configuration of the client's terminal 2 according to the first exemplary embodiment.

The client's terminal 2 includes an operation determiner 211 that makes determination about client's operation, a reservation screen generator 212 that generates a reservation screen for receiving reservation, a display controller 213 that controls display of the reservation screen, and a communication controller 214 that controls transmission of information to and reception of information from the reservation management server 4. The operation determiner 211, the reservation screen generator 212, the display controller 213, and the communication controller 214 are implemented by the controller 21 (see FIG. 4).

The operation determiner 211 determines whether client's operation is made via the inputter 24 or the like. Examples of the client's operation include an operation of selecting a purpose of a client expected to use a plurality of reservable services in combination, an operation of specifying a time frame for use of the services, and an operation of making a collective reservation for the services.

The reservation screen generator 212 generates a reservation screen based on information received from the reservation management server 4.

The reservation screen generator 212 generates a reservation screen for receiving a collective reservation for a plurality of reservable services based on a purpose of a client expected to use the services in combination. The reservation screen may receive reservation for not only services provided by business operators but also a space 3 (see FIG. 2) for use of the services.

For example, the reservation screen generator 212 generates a reservation screen for receiving a collective reservation for a combination of a plurality of services associated with a purpose of a client with their use time frames not overlapping each other within a reservable time frame of a space 3.

The display controller 213 controls display of the reservation screen generated by the reservation screen generator 212. The display controller 213 causes the display 25 of the client's terminal 2 to display the reservation screen generated by the reservation screen generator 212. The display contents of the display 25 of the client's terminal 2 are described later.

The communication controller 214 receives information on reservation from the reservation management server 4. Specifically, the communication controller 214 acquires, via the communicator 23, information on a space 3, information on business operators, and information on reservation candidates.

The communication controller 214 transmits information on reservation to the reservation management server 4. Specifically, the communication controller 214 transmits, to the reservation management server 4 via the communicator 23, information indicating a purpose of use of reservable services, time frames for use of a plurality of services by a client, and an instruction to make a collective reservation for the services.

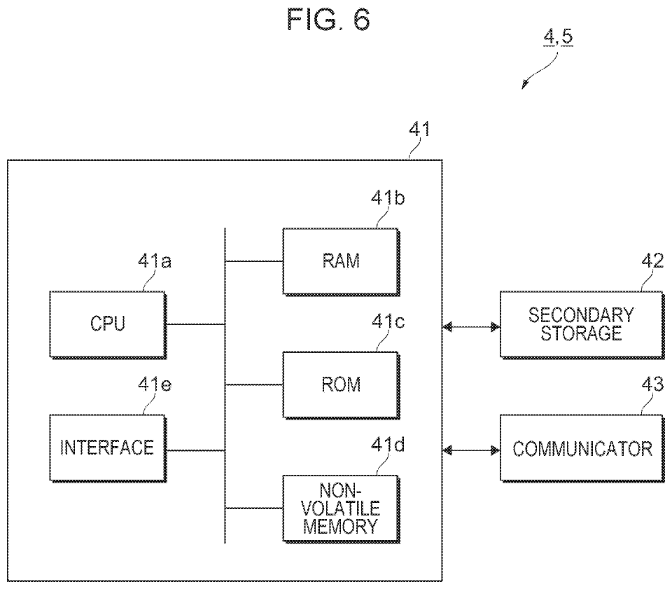

FIG. 6 illustrates an example of the hardware configuration of each of the reservation management server 4 and the schedule management server 5 for use in the first exemplary embodiment.

In this exemplary embodiment, the management server includes a controller 41 that controls overall operation of the apparatus, a secondary storage 42 that stores information on reservation, and a communicator 43 that transmits and receives information via the communication network 8 (see FIG. 2).

The controller 41 includes a CPU 41a that controls the entire apparatus as an example of a processor, a RAM 41b to be used as, for example, a working memory for the CPU 41a, and a ROM 41c that stores, for example, programs to be executed by the CPU 41a. The controller 41 further includes a rewritable non-volatile memory 41d that may retain data even in a case of disruption of power supply, and an interface 41e that controls individual parts of the communicator 23 and other components connected to the controller 41.

Examples of the non-volatile memory 41d include an SRAM and a flash memory backed up by a battery. The controller 41 reads the programs stored in the secondary storage 42 to perform processes of the management server of this exemplary embodiment.

Examples of the secondary storage 42 include a hard disk drive (HDD) and a semiconductor memory. The secondary storage 42 varies depending on commercial forms the reservation management server 4 and the schedule management server 5. For example, the secondary storage 42 stores programs to be executed by the controller 41 and information on reservation.

Next, the functional configuration of the reservation management server 4 is described.

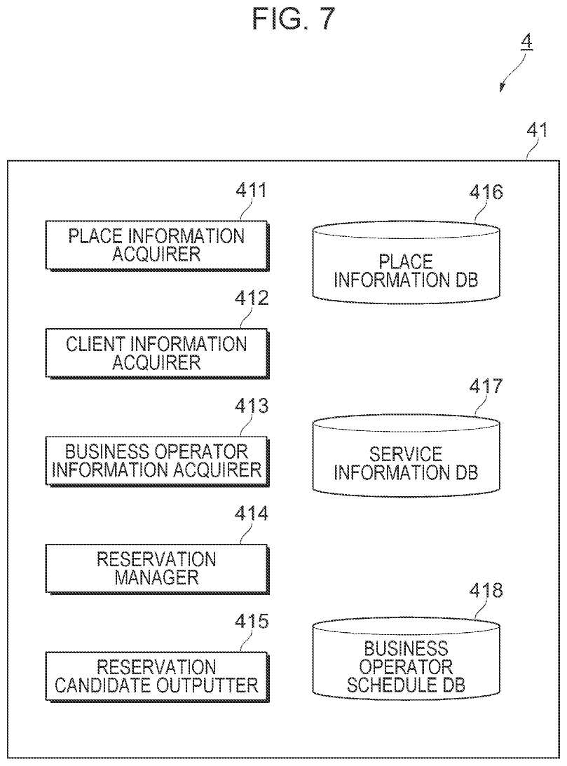

FIG. 7 illustrates an example of the functional configuration of the reservation management server 4 according to the first exemplary embodiment. The functions of the reservation management server 4 illustrated in FIG. 7 are implemented by, for example, the CPU 41a of the controller 41.

As illustrated in FIG. 7, the reservation management server 4 includes a place information acquirer 411, a client information acquirer 412, a business operator information acquirer 413, a reservation manager 414, and a reservation candidate outputter 415. The reservation management server 4 further includes a place information DB 416, a service information DB 417, and a business operator schedule DB 418.

The place information acquirer 411 acquires place information on a space 3 (see FIG. 2) from the place information DB 416.

The place information acquirer 411 acquires place information indicating a reservation status of a space 3 where a client is expected to use a plurality of collectively reserved services. In other words, the place information acquirer 411 acquires place information indicating a schedule of a space 3 where a client is expected to use a plurality of collectively reserved services.

The place information acquirer 411 acquires information for identifying a space 3 where a client is expected to use a plurality of collectively reserved services. As described above, examples of the information for identifying the space 3 include information for identifying an address or a location, a management name, and a management number.

The client information acquirer 412 acquires client information received from a client via the communicator 43 (see FIG. 6). For example, the client information acquirer 412 prompts a client to input information via the client's terminal 2 and acquires the input information via the communication network 8 (see FIG. 2).

Examples of the client information include information indicating a purpose of a client, information indicating a reserved time frame specified by a client, information for identifying a client, and information for identifying a space 3 to be used by a client.

The client information acquisition method of the client information acquirer 412 is not limited to the above method.

The business operator information acquirer 413 acquires business operator information indicating business operators based on the client information acquired by the client information acquirer 412. Specifically, the business operator information acquirer 413 acquires business operator information on business operators whose schedules are managed by the schedule management server 5 (see FIG. 2).

The business operator information acquirer 413 acquires, from the service information DB 417, information for identifying services associated with a purpose of a client among services provided by business operators.

The business operator information acquirer 413 acquires, from the business operator schedule DB 418, schedules of business operators that provide services associated with a purpose of a client.

The reservation manager 414 manages reservations for the spaces 3 (see FIG. 2). Specifically, the reservation manager 414 performs reservation processes for the spaces 3 managed by the reservation management server 4 and manages information indicating reservation statuses of the spaces 3.

The reservation manager 414 manages reservations for a plurality of services associated with a purpose of a client. Specifically, the reservation manager 414 performs reservation processes for services associated with a purpose of a client and manages information indicating reservation statuses of business operators that provide the services.

The reservation manager 414 combines a plurality of services associated with a purpose of a client with their use time frames not overlapping each other within a reservable time frame of a space 3 (see FIG. 2). The reservation manager 414 extracts the combination results as reservation candidates.

The reservation manager 414 may combine a plurality of services associated with a purpose of a client with their use time frames not overlapping each other irrespective of a reservable time frame of a space 3. In this case, the services may be combined, for example, within a period specified by the client as desired use time frames of the services, within a predetermined period from acquisition of client information indicating the purpose of the client, or within a period that reflects schedules of business operators that provide the services.

Description is made about information on services based on a purpose of a client (hereinafter referred to as “service information”) for use in extraction of reservation candidates.

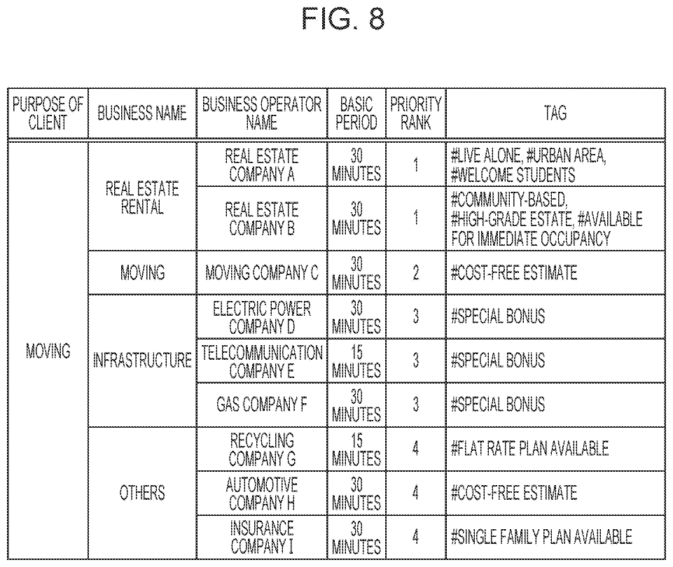

FIG. 8 illustrates an example of the service information based on a purpose of a client. FIG. 8 illustrates information for identifying services associated with the purpose of the client.

In the example of FIG. 8, the purpose of the client is a “moving” procedure.

In the example of FIG. 8, the service information based on the purpose of the client includes business names and business operator names of the services associated with the purpose of the client, basic periods and priority ranks of the services associated with the purpose of the client, and tags set for the services associated with the purpose of the client.

The business name indicates a type of business providing a service associated with the purpose of the client. The business operator name is the name of a business operator of the business with that business name.

The item “others” in the business name field includes, for example, services that may be related to the purpose of the client. In this case, the business operator name is the name of a business operator of business providing a service that may be related to the purpose of the client.

The basic period is a basic expected period of a service of a business operator. The basic period is used for estimating an end time of the service of the business operator.

The tag is a word or short phrase indicating attribute and feature of a service associated with the purpose of the client. If the client sets conditions on services to be extracted together with the purpose, the services may be identified based on tag information.

The priority ranks as an example of priority levels are assigned to services based on at least one of a providing sequence, usage counts, or evaluations of services expected to achieve the purpose of the client. The usage count may be a predetermined minimum usage count to complete one service, or may be an average usage count involving other clients. The priority ranks may be assigned to services based on requests from business operators that provide the services.

In the example illustrated in FIG. 8, the priority ranks are assigned to services that are based on business names in accordance with the providing sequence of the services. In other words, the priority ranks are assigned to services that are based on details of businesses of business operators in accordance with the providing sequence of the services.

If the purpose of the client is the “moving” procedure, the procedures of determining a moving schedule and infrastructure do not generally advance unless a real estate to move in has been determined. Therefore, as illustrated in FIG. 8, a priority rank “1” is assigned to a real estate rental business, a priority rank “2” is assigned to a moving business, and a priority rank “3” is assigned to an infrastructure business.

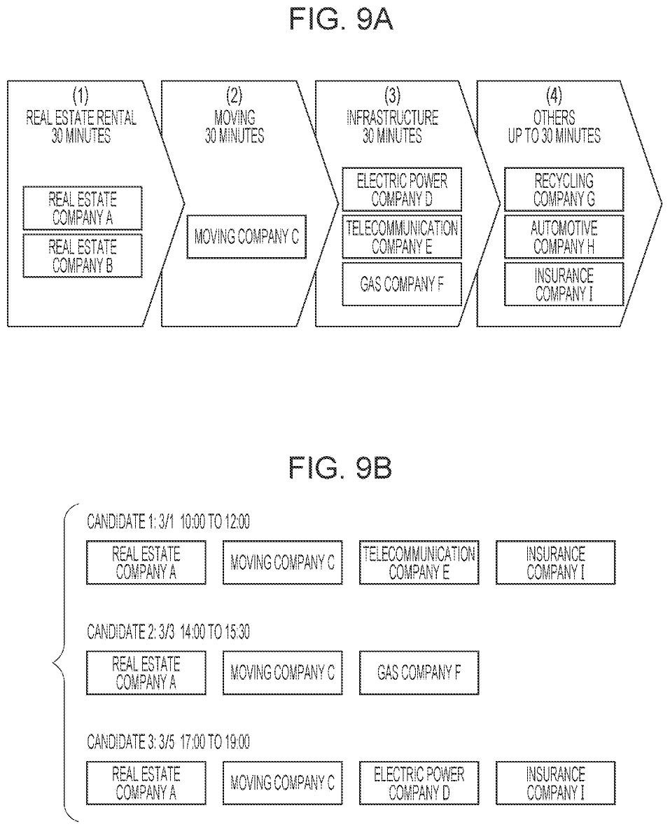

FIGS. 9A and 9B illustrate extraction of reservation candidates. FIG. 9A illustrates an examining sequence on combinations of a plurality of services associated with the purpose of the client. FIG. 9B illustrates extracted reservation candidates.

In the example of FIGS. 9A and 9B, reservation is not made for a space 3 as a place for use of the services.

In the example of FIG. 9A, business operators to reserve are extracted for the individual business names in accordance with the priority ranks illustrated in FIG. 8. Specifically, referring to the schedules of the business operators in accordance with the priority ranks, business operators to reserve are extracted so that the use time frames of the plurality of services are arranged in sequence.

Business operators to reserve may be extracted in accordance with the priority ranks based on evaluations from a plurality of clients who have actually used the services provided by the business operators with the same details of business.

First, a reservable time frame of a “real estate company A” or a “real estate company B” in the real estate rental business having the priority rank “1” is extracted. A reservable time frame of a “moving company C” in the moving business having the priority rank “2” is extracted subsequently to a use time frame of a real estate rental service within the extracted time frame.

A reservable time frame of an “electric power company D”, a “telecommunication company E”, or a “gas company F” in the infrastructure business having the priority rank “3” is extracted subsequently to a use time frame of a moving service within the sequential reservable time frames of the real estate rental service and the moving service.

If a reservation may be made for a “recycling company G”, an “automotive company H”, or an “insurance company I” in other business within the sequential reservable time frames of the real estate rental service, the moving service, and the infrastructure service, a service of the other business is combined. If a reservation is not available for the “recycling company G”, the “automotive company H”, or the “insurance company I” in the other business, the service of the other business need not be combined.

If the priority ranks assigned to services provided by business operators in the same business differ from each other, the reservation candidates may include a service provided by a business operator having a higher priority rank over the other.

As described above, combinations of the plurality of services associated with the purpose of the client are examined and reservation candidates are extracted as illustrated in FIG. 9B.

In the example illustrated in FIG. 9B, a candidate 1, a candidate 2, and a candidate 3 are extracted as the reservation candidates.

In the candidate 1, the reserved time frame is “10:00 to 12:00 on 3/1”, and a collective reservation may be made for the use of the services in the order of the “real estate company A”, the “moving company C”, the “telecommunication company E”, and the “insurance company I”. In the candidate 1, a 15-minute break is provided after the reserved time frame of the “telecommunication company E” whose basic service period is 15 minutes.

Similarly in the candidate 2 and the candidate 3, the reserved time frame and the business operators to reserve by the collective reservation are shown.

The description returns to FIG. 7.

The reservation candidate outputter 415 outputs the information on the reservation candidates extracted by the reservation manager 414 to the client's terminal 2.

Specifically, the reservation candidate outputter 415 outputs, to the client's terminal 2 via the communicator 43, information indicating a reserved time frame, combined services, and business operators that provide the services.

The place information DB 416 cumulatively stores place information on spaces 3 (see FIG. 2). Specifically, the place information DB 416 cumulatively stores information for identifying the spaces 3 and reservation statuses of the spaces 3 in association with each other.

The service information DB 417 cumulatively stores service information on services based on purposes of clients. Specifically, the service information DB 417 cumulatively stores information for identifying the services associated with the purposes of the clients.

The business operator schedule DB 418 cumulatively stores schedules of business operators that provide the services associated with the purposes of the clients. For example, using the API, the business operator schedule DB 418 shares the schedules of the business operators managed by the schedule management server 5.

### [Flows of Processes]

Description is made about processing examples of the reservation management server 4 that performs a collective reservation process for a plurality of services associated with a purpose of a client.

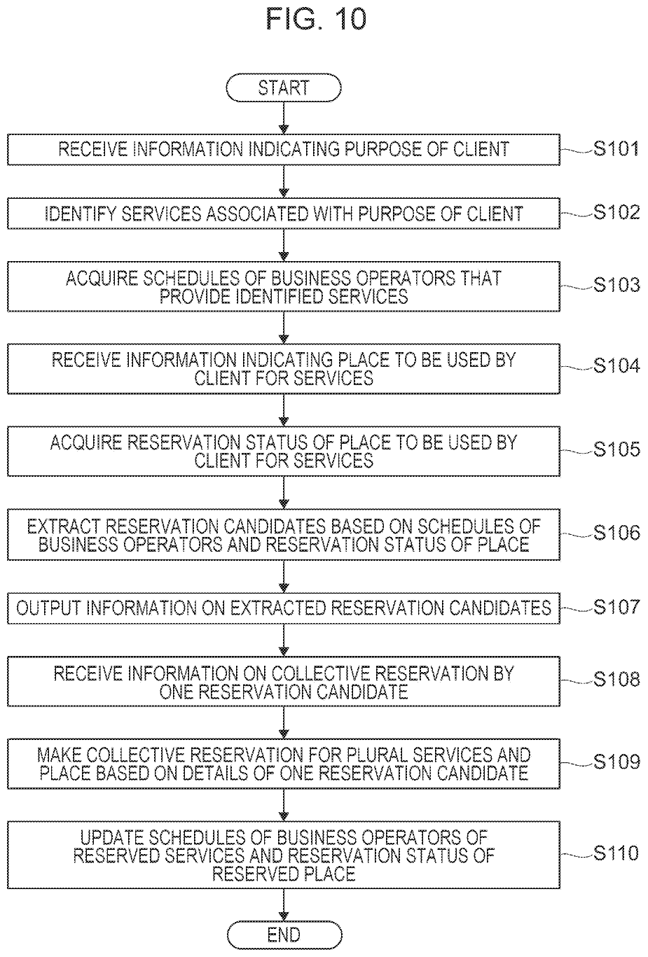

FIG. 10 is a flowchart illustrating a flow of a process for making a collective reservation for a plurality of services associated with a purpose of a client by the reservation management server 4 of the first exemplary embodiment.

The reservation management server 4 receives information indicating a purpose of a client (S101). Specifically, the reservation management server 4 receives client information including a purpose of a client from a client's terminal 2.

The reservation management server 4 identifies services associated with the purpose of the client (S102). Specifically, the reservation management server 4 identifies a plurality of services associated with the purpose of the client based on the service information stored in the service information DB 417.

The service information stored in the service information DB 417 is described.

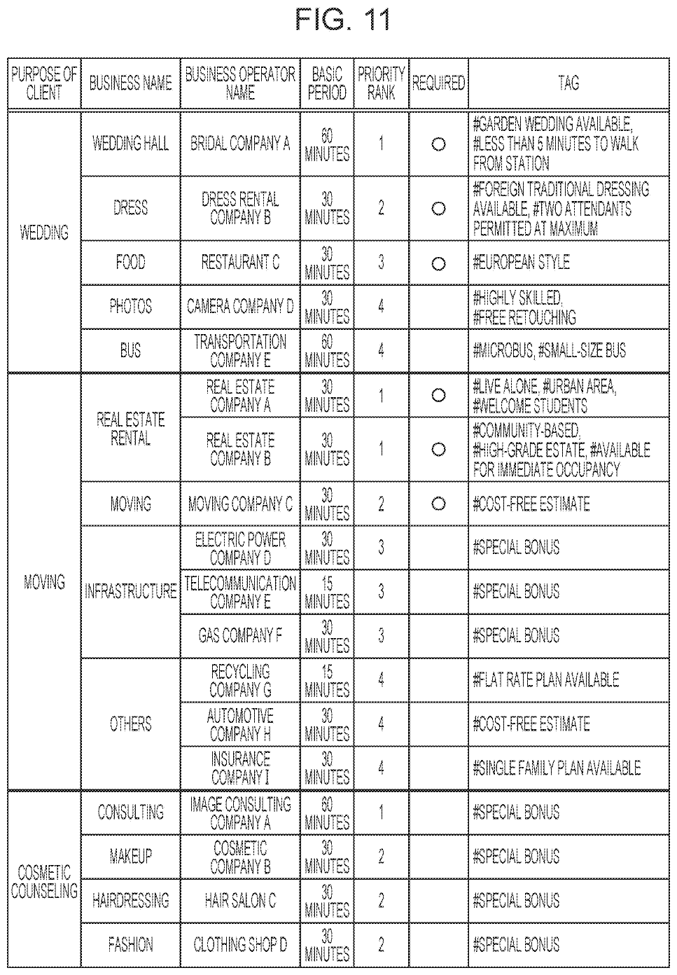

FIG. 11 illustrates an example of the service information stored in the service information DB 417. FIG. 11 illustrates information on services based on various purposes.

In addition to the contents of the service information illustrated in FIG. 8, the service information illustrated in FIG. 11 indicates whether a service is required to achieve a purpose of a client.

For example, if the purpose of the client is a moving procedure, services associated with the purpose of the client are identified as services with business names “real estate rental”, “moving”, “infrastructure”, and “others” associated with the purpose of the client “moving”.

The reservation management server 4 acquires schedules of business operators that provide the identified services (S103). Specifically, the reservation management server 4 acquires schedules of business operators from the business operator schedule DB 418 that shares information with the schedule management server 5.

The schedules of the business operators shared in the business operator schedule DB 418 are described.

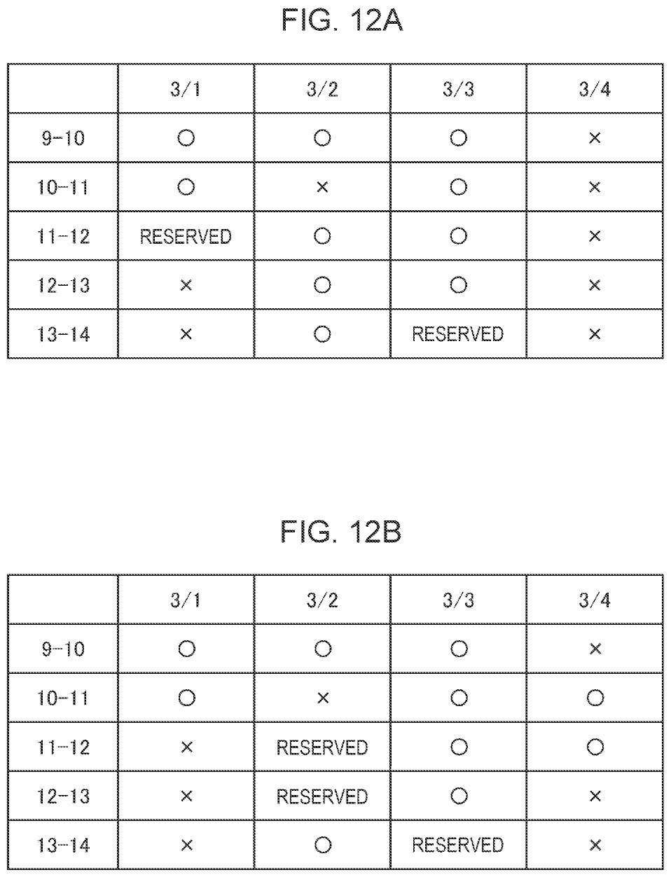

FIGS. 12A and 12B illustrate examples of the schedules of the business operators stored in the business operator schedule DB 418. FIG. 12A illustrates a schedule of the real estate company A. FIG. 12B illustrates a schedule of the real estate company B.

In the example illustrated in FIG. 12A, “o” represents a time frame reservable by making a reservation for the service provided by the real estate company A, “reserved” represents a time frame that has already been reserved by a different client or the like, and “x” represents a time frame that is not reservable.

The example illustrated in FIG. 12B shows whether a reservation for the service provided by the real estate company B may be made for each predetermined time frame similarly to the above.

The schedules of the business operators showing whether a reservation may be made for each predetermined time frame are acquired as described above.

The reservation management server 4 receives information indicating a place to be used by the client for the services (S104). Specifically, the reservation management server 4 receives, from the client's terminal 2, client information including information indicating a space 3 (see FIG. 2) to be used by the client.

The reservation management server 4 acquires a reservation status of the place to be used by the client for the services (S105). Specifically, the reservation management server 4 acquires a reservation status of the space 3 from the place information DB 416.

In this exemplary embodiment, if the client information includes information indicating a booth 30 (see FIG. 3) to be used by the client for the services, a schedule showing reservable time frames of the booth 30 is acquired.

Reservation statuses of places stored in the place information DB 416 are described.

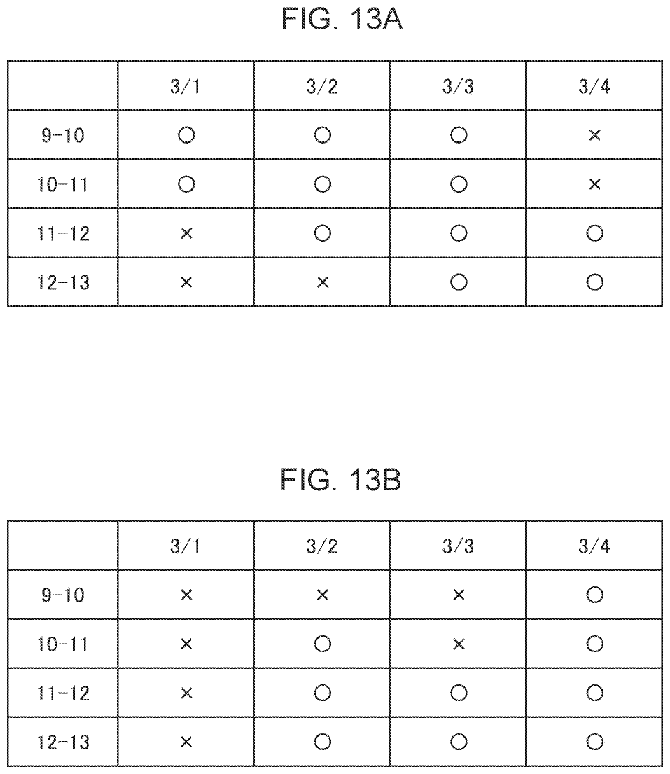

FIGS. 13A and 13B illustrate examples of the reservation statuses of the places stored in the place information DB 416. FIG. 13A illustrates a reservation status of a booth A. FIG. 13B illustrates a reservation status of a booth B.

In the example illustrated in FIG. 13A, “o” represents a reservable time frame of the booth A among the booths 30 (see FIG. 3), and “x” represents a time frame that has already been reserved by a different client or the like.

The example illustrated in FIG. 13B shows whether a reservation for the booth B may be made for each predetermined time frame similarly to the above.

If the client desires, for example, the booth A for the services, the reservation status of the booth A illustrated in FIG. 13A is acquired.

The reservation management server 4 extracts reservation candidates based on the schedules of the business operators and the reservation status of the place (S106). Specifically, the reservation management server 4 extracts combinations of services associated with the purpose of the client with their use time frames not overlapping each other within the reservable time frame of the place.

For example, the reservation management server 4 extracts reservation candidates so that the services with the business names “real estate rental”, “moving”, “infrastructure”, and “others” associated with the purpose of the client “moving” may be used in sequence within the reservable time frame of the booth A selected by the client. More specifically, the reservation management server 4 extracts reservation candidates so that at least the services with the business names “real estate rental” and “moving” required to achieve the purpose of the client “moving” among the plurality of services associated with the purpose of the client may be used in sequence in the booth A.

The reservation management server 4 may arrange the plurality of services in sequence from a time specified by the client, or may maximally arrange the plurality of services in sequence within a time frame specified by the client.

For example, the reservation management server 4 may provide a break in the reservation if the plurality of services associated with the purpose of the client “moving” are combined in sequence within the reservable time frame of the booth A selected by the client.

More specifically, the reservation management server 4 may provide a break in the reservation between the service with the business name “real estate rental” and the service with the business name “moving” if determination is made that a predetermined condition is satisfied for the use of the plurality of services associated with the purpose of the client “moving”.

Examples of the predetermined condition include a condition that the number of services in the reservation candidate is larger than a threshold, a condition that the expected period to complete all the services is longer than a threshold, and a condition that different business operators provide the services whose use time frames are arranged in sequence. Examples of the predetermined condition also include a condition that the expected period of one service is longer than a threshold, and a condition that a break is recommended after one service.

The reservation management server 4 outputs information on the extracted reservation candidates to the client's terminal 2 of the client (S107).

The client's terminal 2 causes the display 25 to display a reservation screen based on the received information.

Description is made about the screen on the client's terminal 2 that has received the information on the reservation candidate from the reservation management server 4.

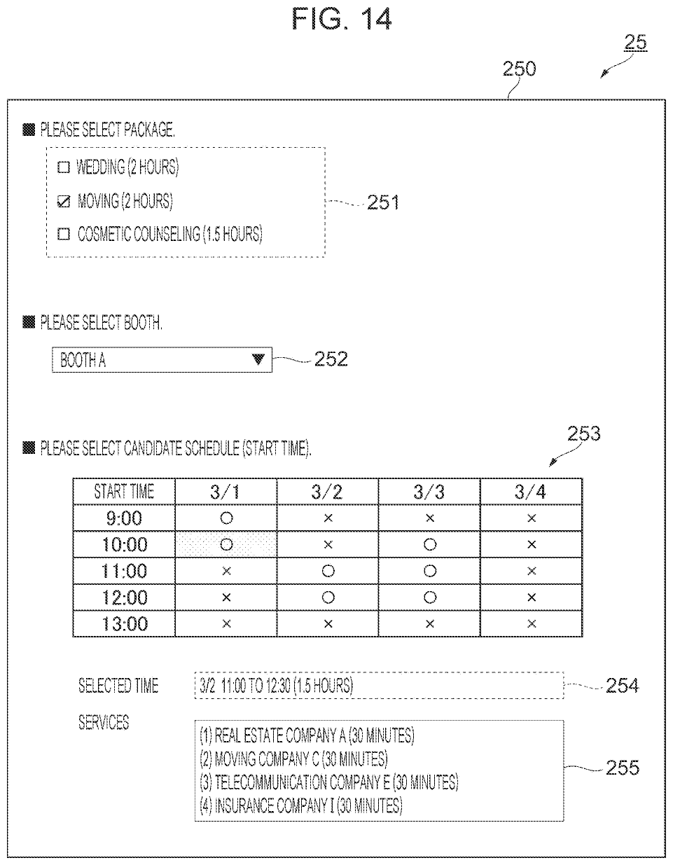

FIG. 14 illustrates an example of a reservation screen for receiving a reservation for services.

In the example of FIG. 14, information indicating a purpose of a client is acquired based on a selected package.

In the display example illustrated in FIG. 14, the display 25 of the client's terminal 2 displays a reservation screen 250 for receiving a collective reservation for a plurality of reservable services based on the purpose of the client expected to use the services in combination.

The reservation screen 250 displays a purpose selection image 251, a place selection image 252, a time selection image 253, a reserved time frame field 254, and a combination field 255.

The purpose selection image 251 is an image for receiving a client's operation for selecting the purpose of the client. In other words, the purpose selection image 251 is an operation image for receiving a purpose specifying operation from the client. In the purpose selection image 251, operation receiving checkboxes, package names to be associated with the purpose of the client, and basic expected periods of the packages are associated with each other.

The place selection image 252 is an image for receiving a client's operation for selecting a place for use of services. For example, place candidates for use of services are presented in response to selection of a predetermined area in the place selection image 252, and the client selects any one of the place candidates.

The time selection image 253 is an image for receiving a client's operation for selecting a start time of reserved services. Specifically, the time selection image 253 is a selection image for receiving, from the client, an operation of selecting use time frames from reservable time frames of a combination of a plurality of services associated with the purpose.

In this exemplary embodiment, any area with a symbol “o” is selected in the time selection image 253 and a start time associated with the selected area is selected.

The reserved time frame field 254 is a field for displaying information on a reserved time frame from the start time selected in the time selection image 253.

The combination field 255 is a field for displaying, for example, a providing sequence of the combination of services reservable within the reserved time frame displayed in the reserved time frame field 254, business operator names of the services, and expected periods of the services.

In this exemplary embodiment, the time selection image 253 is displayed in response to the client's selection in the purpose selection image 251 and the place selection image 252. Alternatively, the time selection image 253 may be displayed on the reservation screen 250 before the selection in the purpose selection image 251 and the place selection image 252. In this case, the display of the time selection image 253 is updated in response to the selection in the purpose selection image 251 and the place selection image 252.

In this exemplary embodiment, a confirmation button image (not illustrated) for receiving an instruction to confirm the reservation is selected with the start time selected in the time selection image 253. In this case, the client's terminal 2 requests the reservation management server 4 to make a collective reservation for the services in the reservation candidate and the place.

In the example illustrated in FIG. 14, the plurality of services in the reservation candidate are provided by different business operators displayed in the combination field 255. In this case, the client's terminal 2 requests the reservation management server 4 to make a collective reservation for the plurality of business operators that provide the services in the reservation candidate.

The reservation management server 4 receives information on a collective reservation by one reservation candidate (S108). Specifically, the reservation management server 4 receives, from the client's terminal 2, client information indicating a request to make a collective reservation for one reservation candidate selected by the client.

The reservation management server 4 makes a collective reservation for the plurality of services and the place based on the details of the one reservation candidate (S109). Specifically, the reservation management server 4 makes a collective reservation for the place selected by the client and the plurality of services combined with their use time frames not overlapping each other from the start time selected by the client.

The reservation management server 4 updates the schedules of the business operators that provide the reserved services and the reservation status of the reserved place (S110), and terminates the process. In other words, the reservation management server 4 updates the schedules of the business operators and the reservation status of the place based on a result of the collective reservation, and terminates the process.

Although description is omitted above, in a case where a client uses a terminal apparatus to use services in a reservation candidate, a collective reservation may be made for a plurality of services combined with their use time frames not overlapping each other and a place where the terminal apparatus is installed.

To identify the services in the reservation candidates, a condition for filtering the services associated with the purpose of the client (hereinafter referred to as “filtering condition”) may be used as well as the purpose of the client.

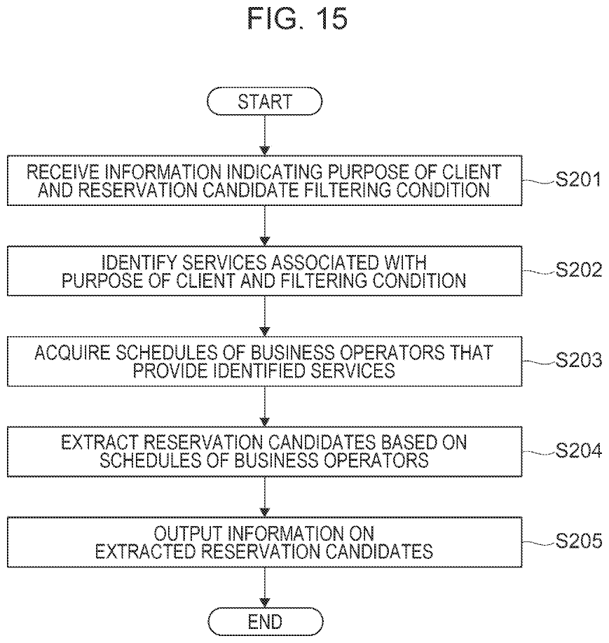

FIG. 15 is a flowchart illustrating a flow of a process for making a collective reservation for a plurality of services associated with the purpose of the client and the filtering condition by the reservation management server 4 of the first exemplary embodiment.

In the example of FIG. 15, the client does not make a reservation for a place for use of the plurality of reserved services. In this case, the client uses the reserved services at a place with no need for reservation, such as a client's home.

The reservation management server 4 receives information indicating a purpose of a client and a reservation candidate filtering condition (S201). Specifically, the reservation management server 4 receives, from a client's terminal 2, client information including a purpose of a client and a reservation candidate filtering condition.

The reservation management server 4 identifies services associated with the purpose of the client and the filtering condition (S202). Specifically, the reservation management server 4 identifies a plurality of services associated with the purpose of the client based on the service information stored in the service information DB 417.

The service information associated with the purpose of the client is described.

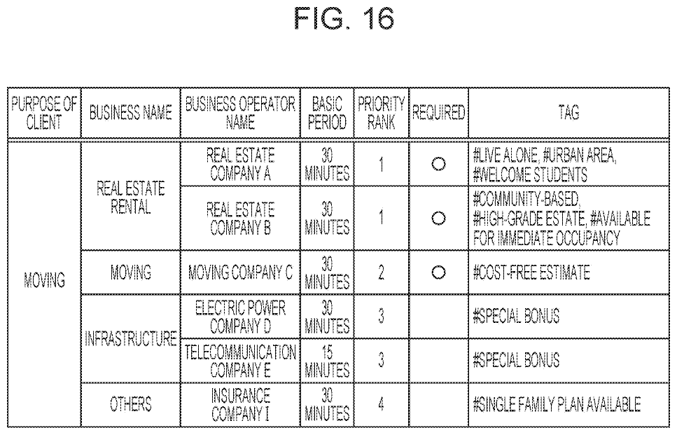

FIG. 16 illustrates an example of the service information stored in the service information DB 417. FIG. 16 illustrates information on services based on the purpose of the client.

In the example of FIG. 16, the client sets the filtering condition while selecting the purpose of the client.

For example, if the purpose of the client is a moving procedure, a filtering condition is set to request reservations for an electricity-related service and an insurance-related service different from required services among the services associated with the purpose of the client. In this case, as illustrated in FIG. 16, service information associated with the purpose of the client and the reservation candidate filtering condition is identified in the service information illustrated in FIG. 11. In this manner, the services associated with the purpose of the client and the reservation candidate filtering condition are identified.

The reservation management server 4 acquires schedules of business operators that provide the identified services (S203). Specifically, the reservation management server 4 acquires schedules of business operators from the business operator schedule DB 418 that shares information with the schedule management server 5.

The reservation management server 4 extracts reservation candidates based on the schedules of the business operators (S204). Specifically, the reservation management server 4 extracts combinations of services associated with the purpose of the client and the reservation candidate filtering condition with their use time frames not overlapping each other.

Schedules of business operators for use in the extraction of reservation candidates are described.

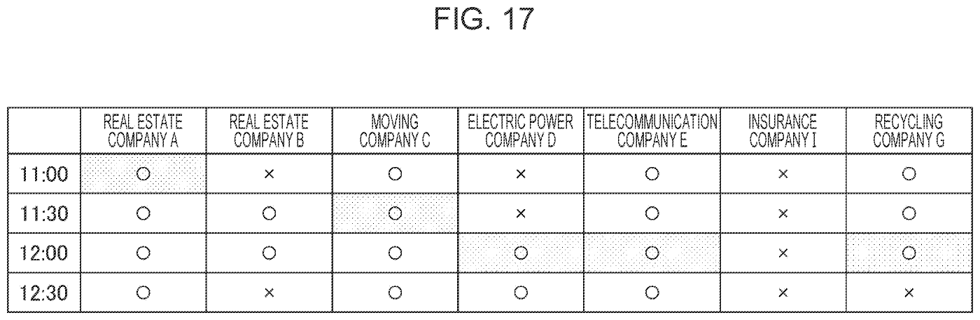

FIG. 17 illustrates extraction of reservation candidates based on schedules of business operators.

In the example of FIG. 17, the purpose of the client is selected and the filtering condition is set similarly to FIG. 16. Therefore, FIG. 17 illustrates schedules on a certain date for business operators in the service information illustrated in FIG. 16.

The schedules are referenced sequentially from a business operator that provides a service with the highest priority rank among the services required to achieve the purpose of the client.

For example, a time frame from “11:00” in which a reservation is received for the service provided by the real estate company A is identified as the earliest reservable time frame of the service with the highest priority rank among the services required to achieve the purpose of the client. Determination is made as to whether a reservation is received, subsequently to the identified time frame, for a service with the second highest priority rank among the services required to achieve the purpose of the client. In the example illustrated in FIG. 17, a reservation for the service provided by the moving company C is received in a time frame from “11:30” at which the service provided by the real estate company A is expected to finish.

Then, schedules of business operators that provide services not required to achieve the purpose of the client but satisfying the filtering condition are referenced sequentially.

For example, a reservation for the service provided by the electric power company D or the telecommunication company E is received in a time frame from “12:00” at which the service provided by the moving company C is expected to finish.

A reservation for the service provided by the insurance company I is not received in the time frame from “12:00”. In this case, the earliest time frame may be extracted for a collective reservation including the service provided by the insurance company I.

A service not satisfying the filtering condition, such as the service provided by the recycling company G, may be included in the reservation candidate if the service is related to the required services or the services satisfying the filtering condition.

The reservation management server 4 outputs information on the extracted reservation candidates to the client's terminal 2 of the client (S205).

The client's terminal 2 causes the display 25 to display a reservation screen based on the received information.

Another example of the screen on the client's terminal 2 is described.

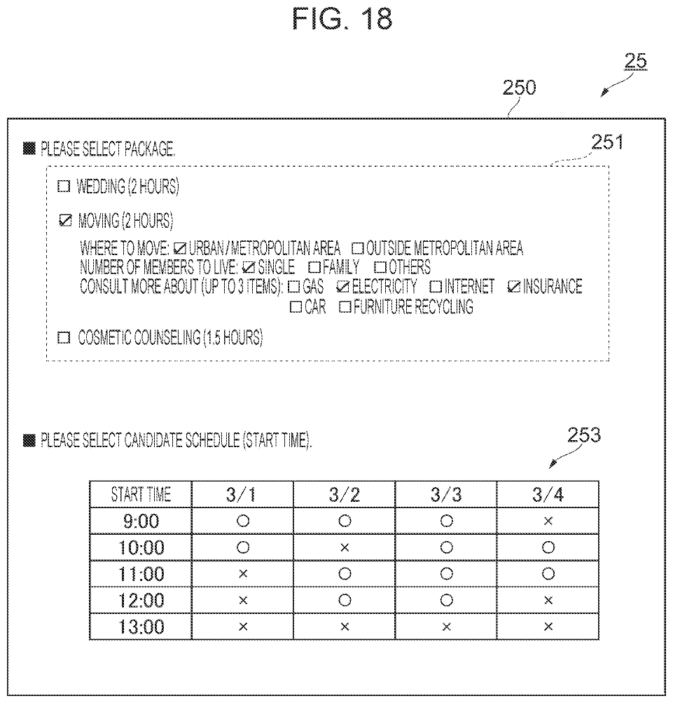

FIG. 18 illustrates another example of the reservation screen for receiving a reservation for services.

The screen illustrated in FIG. 18 differs from the reservation screen 250 illustrated in FIG. 14 in that the setting of the filtering condition is received. The difference from the reservation screen 250 illustrated in FIG. 14 is described below.

In the display example illustrated in FIG. 18, the screen displays a purpose selection image 251 for presenting candidates for the filtering condition based on the purpose of the client, and a time selection image 253 for receiving an operation of selecting reserved time frames of a combination of services associated with the purpose of the client and the reservation candidate filtering condition.

The display of the place selection image 252 (see FIG. 14) is omitted.

In this processing example, the purpose selection image 251 is an image for receiving a client's operation for selecting the filtering condition based on the selected purpose of the client. The filtering condition is a condition on details of a plurality of services, and is a condition for selecting a plurality of services associated with the purpose of the client.

In the example illustrated in FIG. 18, texts associated with candidates for the filtering condition and operation receiving checkboxes are associated with each other in each item.

Specifically, candidates for the filtering condition are presented to confine the location to move in to “urban/metropolitan area” or “outside metropolitan area”. With this filtering condition, business operators that may provide services continuously are selected.

Candidates for the filtering condition are presented to confine the number of expected members to live to “single”, “family”, or “others”. With this filtering condition, business operators that may provide services desired by the client are selected.

Candidates for the filtering condition are presented to select services to be collectively reserved by the client. With this filtering condition, business types of services to be collectively reserved are selected.

Candidates for the filtering condition may be presented to select, for example, the sex and age of a person in charge of actually providing a service to the client.

In this processing example, the candidates for the filtering condition on the moving procedure are presented in response to selection of a package name “moving” associated with the purpose of the client.

Alternatively, the candidates for the filtering condition based on the purpose of the client may be displayed before the reception of the client's operation for selecting the purpose of the client. In this case, the candidates for the filtering condition may be displayed for each package name associated with the purpose of the client.

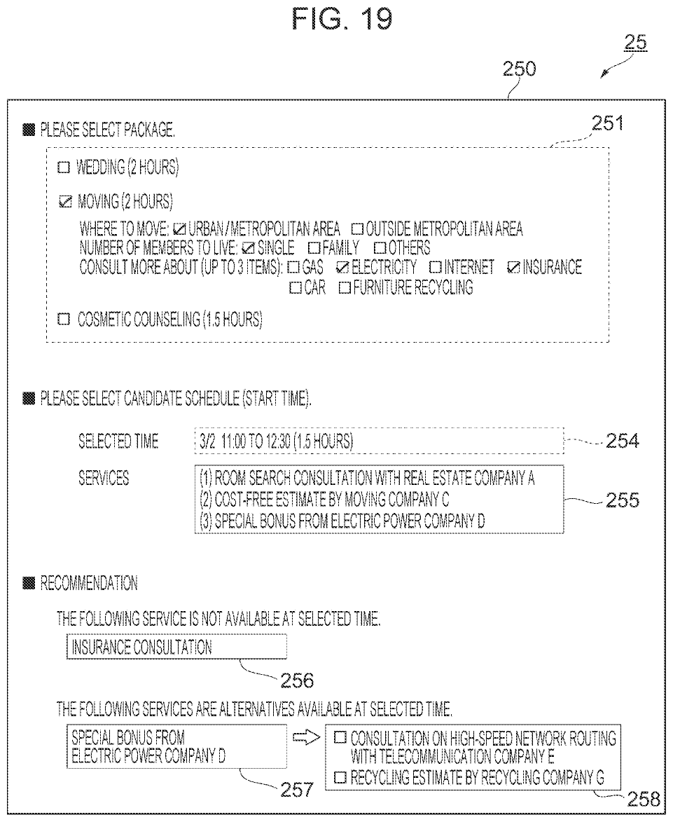

FIG. 19 illustrates another example of the reservation screen for receiving a reservation for services.

In the example of FIG. 19, “11:00 on 3/2” has been selected by the client in the time selection image 253 on the reservation screen 250 illustrated in FIG. 18.

The screen illustrated in FIG. 19 differs from the reservation screen 250 illustrated in FIG. 14 in that information is presented on services not included in one reservation candidate selected by the client. The differences from the reservation screens 250 illustrated in FIGS. 14 and 18 are described below.

In the display example illustrated in FIG. 19, an unavailable service field 256, a changeable service field 257, and a recommended alternative field 258 are displayed in addition to the purpose selection image 251, the reserved time frame field 254, and the combination field 255.

Although the time selection image 253 (see FIG. 18) is hidden in response to the client's selection of the start time of the reserved time frame, the display of the time selection image 253 may be maintained.

Although the package “moving” whose basic expected period is 2 hours has been selected, the reserved time frame field 254 shows that the reserved time frame from the start time “11:00 on 3/2” selected by the client is “11:00 to 12:30 on 3/2 (1.5 hours)”.

The combination field 255 displays a combination of services reservable within the reserved time frame “11:00 to 12:30 on 3/2 (1.5 hours)”.

The unavailable service field 256 is a field for displaying information on a service unavailable in the reservation candidate selected by the client among the services associated with the purpose of the client and the reservation candidate filtering condition. For example, the unavailable service field 256 displays an insurance service “insurance consultation” that is not reservable within the reserved time frame “11:00 to 12:30 on 3/2 (1.5 hours)”.

In this processing example, information on a changeable service among the services in the reservation candidate is presented and a change of the combination in the reservation candidate is received.

The changeable service field 257 is a field for displaying information on a service changeable to any other service among the services displayed in the combination field 255.

The recommended alternative field 258 is a field for displaying information on a service available within the reserved time frame of the service displayed in the changeable service field 257. In other words, the recommended alternative field 258 is a field for displaying information on a service reservable within the reserved time frame of the service displayed in the changeable service field 257. In the example illustrated in FIG. 19, texts associated with services changeable from the service in the reservation candidate and operation receiving checkboxes are associated with each other.

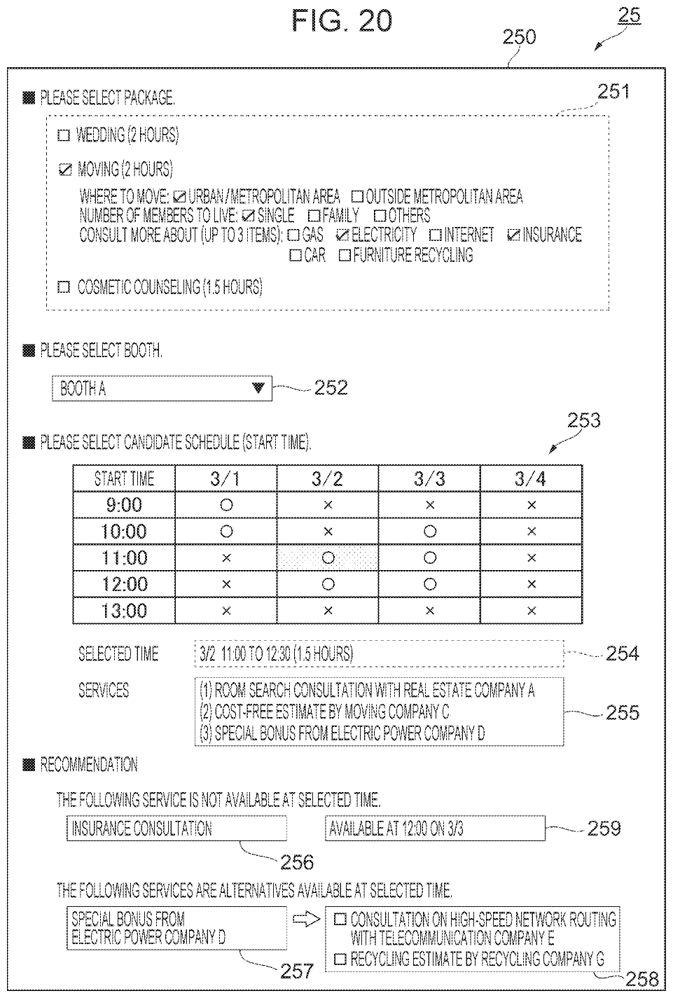

FIG. 20 illustrates another example of the reservation screen for receiving a reservation for services.

In the example of FIG. 20, the client has selected the booth A as a place for use of services.

The screen illustrated in FIG. 20 differs from the reservation screen 250 illustrated in FIG. 19 in that a reservable time frame of a service not included in one reservation candidate selected by the client is presented. The difference from the reservation screen 250 illustrated in FIG. 19 is described below.

In the display example illustrated in FIG. 20, an alternative schedule field 259 is displayed in addition to the purpose selection image 251, the reserved time frame field 254, the combination field 255, the unavailable service field 256, the changeable service field 257, and the recommended alternative field 258.

In the display example illustrated in FIG. 20, the place selection image 252 and the time selection image 253 are displayed.

The alternative schedule field 259 is a field for displaying information on a time frame in which a collective reservation may be made including the service currently unavailable in the reservation candidate selected by the client.

In this processing example, a collective reservation may be made for the booth A and a plurality of services including “insurance consultation” if a reserved time frame from “12:00 on 3/3” is selected.

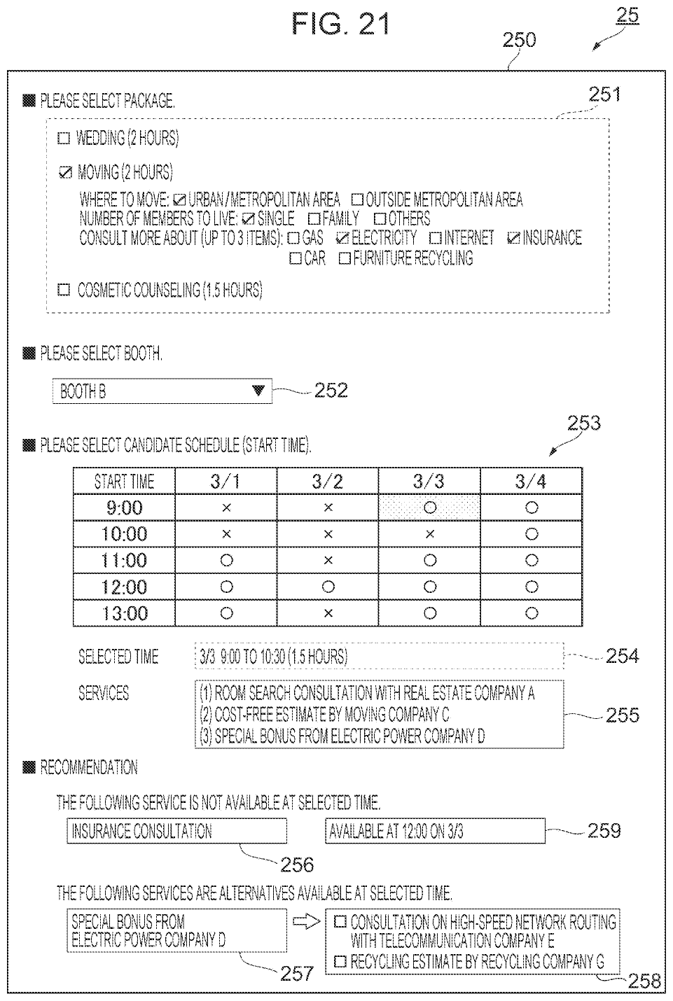

FIG. 21 illustrates another example of the reservation screen for receiving a reservation for services.

In the example of FIG. 21, the client has changed the place for use of services to the booth B in the place selection image 252 on the reservation screen 250 illustrated in FIG. 20.

In response to the selection of the booth B as the place for use of services, the information in the place selection image 252 is changed. Specifically, the information is updated in association with a reservation candidate to make a collective reservation for the services required to achieve the purpose of the client and the booth B.

The wedding procedure, the moving procedure, and the cosmetic counseling are examples of the purpose for which a collective reservation is received for a plurality of services. The collective reservation system of this exemplary embodiment may also be applied to use of services provided by business operators in different businesses, such as an inheritance procedure and event preparation.

In the examples described above, the types of the plurality of services in the reservation candidate differ from each other, but a collective reservation may be made for business operators that provide services of the same type.

In a case where services are used for comparing business operators in the same business such as sale for real estate, sale for automobiles, selection of private schools, or study-abroad consultation, a collective reservation may be made for business operators that provide services of the same type. In this case, the reservation candidate may be extracted in accordance with priority ranks based on evaluations from a plurality of clients who have actually used the services.

The plurality of services collectively reserved by the client may be canceled not only by a client's instruction but also by an instruction from a business operator that provides the reserved service.

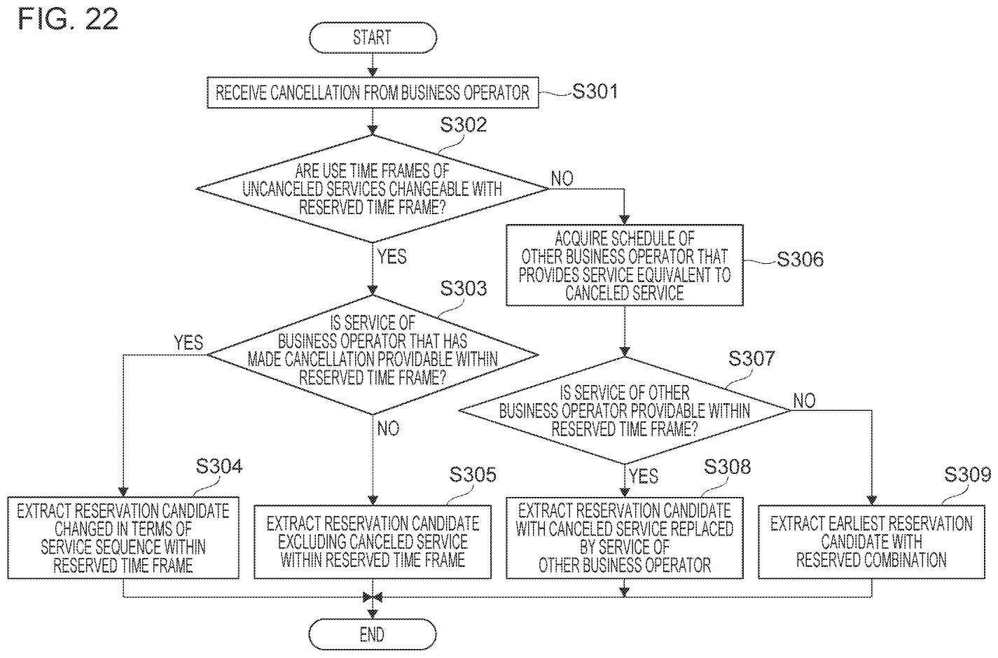

FIG. 22 is a flowchart illustrating a flow of a process for recombining a plurality of collectively reserved services by the reservation management server 4 of the first exemplary embodiment.

In the example of FIG. 22, a business operator that provides one service out of the plurality of collectively reserved services has canceled the reservation for the one service.

The reservation management server 4 receives the cancellation from the business operator (S301). Specifically, the reservation management server 4 receives, from a business operator's terminal 6, business operator information indicating that the business operator that provides the one service out of the plurality of collectively reserved services requests the cancellation of the reservation for the one service.

The reservation management server 4 determines whether the use time frames of uncanceled services are changeable within the collectively reserved time frame (S302). Specifically, the reservation management server 4 determines, based on the schedules of the business operators that provide the collectively reserved services, whether the use time frames of the uncanceled services are changeable within the collectively reserved time frame.

If the use time frames of the uncanceled services are changeable within the collectively reserved time frame (“YES” in S302), the reservation management server 4 determines whether the service of the business operator that has made the cancellation is providable within the collectively reserved time frame (S303). Specifically, the reservation management server 4 determines, based on the schedules of the plurality of business operators that provide the collectively reserved services, whether the business operator that has requested the cancellation of the reservation is open for reservation for the service within the collectively reserved time frame.

If the service of the business operator that has made the cancellation is providable within the collectively reserved time frame (“YES” in S303), the reservation management server 4 extracts a reservation candidate changed in terms of the sequence of the plurality of collectively reserved services within the collectively reserved time frame (S304), and terminates the process.

If the service of the business operator that has made the cancellation is not providable within the collectively reserved time frame (“NO” in S303), the reservation management server 4 extracts a reservation candidate excluding the canceled service from the plurality of collectively reserved services within the collectively reserved time frame (S305), and terminates the process.

If the use time frames of the uncanceled services are not changeable within the collectively reserved time frame in S302 (“NO” in S302), the reservation management server 4 acquires a schedule of another business operator that provides a service equivalent to the canceled service (S306). Specifically, the reservation management server 4 acquires a schedule of another business operator in a business similar to the business of the business operator that has requested the cancellation of the reservation.

The reservation management server 4 determines whether the service of the other business operator is providable within the collectively reserved time frame (S307). Specifically, the reservation management server 4 determines, based on the schedule of the other business operator in the same business as the business operator that has requested the cancellation of the reservation, whether the other business operator is open for reservation for the service within the collectively reserved time frame.

If the service of the other business operator is providable within the collectively reserved time frame (“YES” in S307), the reservation management server 4 extracts a reservation candidate with the canceled service replaced by the service of the other business operator (S308), and terminates the process.

If the service of the other business operator is not providable within the collectively reserved time frame (“NO” in S307), the reservation management server 4 extracts an earliest reservation candidate with the reserved combination (S309), and terminates the process. The earliest reservation candidate is a combination of a plurality of collectively reserved services within the earliest reserved time frame among the reservable time frames of the combination of the plurality of collectively reserved services.

Although description is omitted above, the reservation candidate with the canceled service replaced by the service of the other business operator may be extracted in a time frame different from the collectively reserved time frame.

In this exemplary embodiment, the reservation management server 4 outputs information on the extracted reservation candidate to the client's terminal 2 of the client who has made the collective reservation. The client's terminal 2 displays the reservation screen 250 based on the information on the reservation candidate to present the new reservation candidate to the client. The reservation management server 4 makes a collective reservation again for the plurality of services based on the details of the new reservation candidate selected by the client via the client's terminal 2.

In the example described above, the reservation management server 4 identifies the business operator that provides the service to be included in the new reservation candidate to recombine the services in the reservation candidate due to the cancellation. For example, the reservation management server 4 may call for the business operator that provides the service to be included in the new reservation candidate.

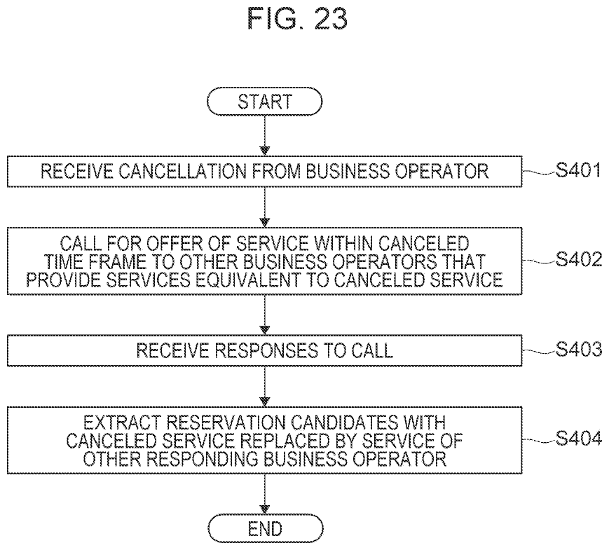

FIG. 23 is a flowchart illustrating a flow of a process for recombining a plurality of services by calling for a business operator by the reservation management server 4 of the first exemplary embodiment.

In the example of FIG. 23, a call is made for a business operator within the use time frame of one canceled service out of the plurality of collectively reserved services.

The reservation management server 4 receives the cancellation from the business operator (S401).

The reservation management server 4 calls for an offer of a service within the canceled time frame to other business operators that provide services equivalent to the canceled service (S402). Specifically, the reservation management server 4 extracts other business operators in businesses similar to the business of the business operator that has made the cancellation based on the service information stored in the service information DB 417. The reservation management server 4 notifies the identified other business operators that the call is made for an offer of a service within the reserved time frame of the service provided by the business operator that has made the cancellation.

The reservation management server 4 receives responses to the call (S403).

Specifically, the reservation management server 4 receives, as responses to the call, business operator information indicating that reservation is receivable for the reserved time frame of the service provided by the business operator that has made the cancellation from business operator's terminals 6 of the notified other business operators.

The reservation management server 4 extracts a reservation candidate with the canceled service replaced by a service of any other business operator responding to the call (S404), and terminates the process.

### Second Exemplary Embodiment

### [Information Processing System 10]

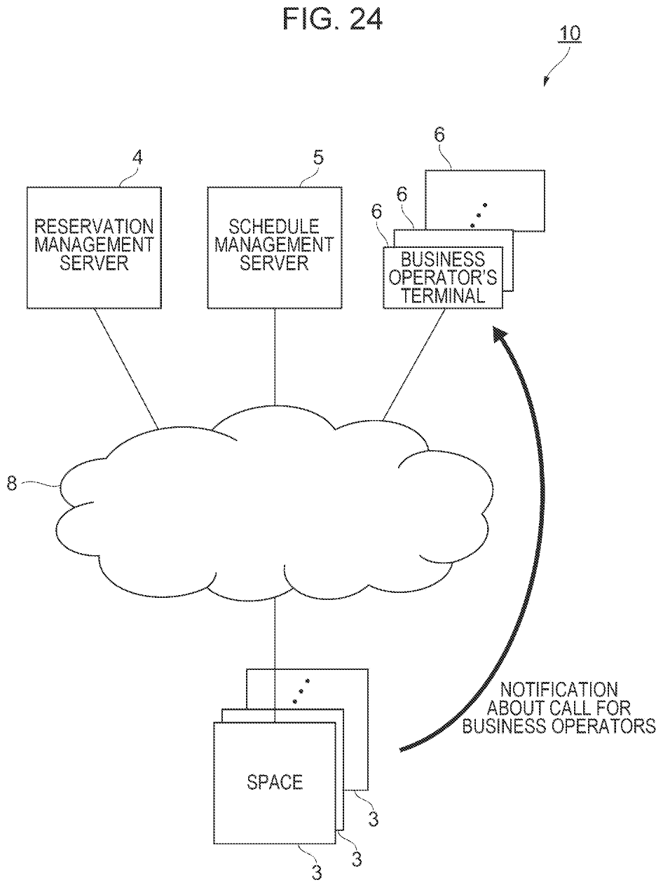

FIG. 24 illustrates an example of the overall configuration of an information processing system 10 according to a second exemplary embodiment.

The information processing system 10 according to the second exemplary embodiment differs from the information processing system 1 according to the first exemplary embodiment in that the client does not make reservation. The difference from the first exemplary embodiment is described below. Elements common to the first exemplary embodiment and the second exemplary embodiment are represented by the same reference symbols and detailed description thereof is omitted.

In the information processing system 10, the spaces 3 where a terminal apparatus is used, the reservation management server 4, the schedule management server 5, and the plurality of business operator's terminals 6 are connected via the communication network 8.

The terminal apparatus to be used in the space 3 may display the reservation screen 250. Examples of the terminal apparatus include the terminal apparatus 31E of the booth 30 (see FIG. 3), a tablet terminal (not illustrated) disposed outside the booth 30, and the client's terminal 2 of the client (see FIG. 2).

In this exemplary embodiment, the client uses the terminal apparatus in the space 3 to notify business operators that provide services associated with the purpose of the client that a call is made for business operators that may provide services from the current time. In other words, if the client who uses the terminal apparatus in the space 3 has not made reservation, an inquiry as to whether services are immediately providable is sent to business operators that provide services associated with the purpose of the client.

The notification of the call for business operators is not limited to the notification via the reservation management server 4. In a case where the client selects a notification destination for the call for business operators, the terminal apparatus operated by the client may notify the selected notification destination that the call is made for business operators.

In the exemplary embodiments, the programs to be executed by the CPUs 21a (see FIG. 4) and 41a (see FIG. 6) as examples of the processor are provided to the controllers 21 and 41 by being stored in computer readable recording media such as magnetic recording media (magnetic tapes, magnetic disks, etc.), optical recording media (optical discs etc.), magneto-optical recording media, and semiconductor memories. The programs to be executed by the CPUs 21a and 41a may be downloaded to the apparatuses using communication tools such as the Internet.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The processes to be performed by the information processing system of each exemplary embodiment are prepared as programs such as application software. The programs may be provided not only by communication tools but also by being stored in recording media such as CD-ROMs.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system comprising:
one or more processors configured to:
   acquire, from a client expected to use a plurality of reservable services in combination, client information including a purpose of the client;
   identify the plurality of services associated with the purpose in the client information;
   acquire business operator information on business operators that provide the plurality of identified services, the business operator information including schedules of the business operators; and
   make a collective reservation for a combination of the plurality of identified services with use time frames of the plurality of services not overlapping each other based on the business operator information.
      (((2)))

The information processing system according to (((1))), wherein the one or more processors are configured to:
if the client information includes information indicating a rental place for use of the plurality of identified services, acquire place information on a schedule of the place; and
make a collective reservation for the place and the combination of the plurality of services with the use time frames not overlapping each other within a reservable time frame of the place based on the business operator information and the place information.
   (((3)))

The information processing system according to (((2))), wherein the one or more processors are configured to:
if a terminal apparatus is used for the use of the plurality of services, make a collective reservation for the place where the terminal apparatus is disposed and the combination of the plurality of services with the use time frames not overlapping each other within the reservable time frame of the place.
   (((4)))

The information processing system according to any one of (((1))) to (((3))), wherein the one or more processors are configured to:
if the business operator information includes information indicating expected periods of the plurality of services provided by the business operators, make a collective reservation for the combination of the plurality of identified services with the use time frames arranged in sequence.
   (((5)))

The information processing system according to (((4))), wherein the one or more processors are configured to:
if a predetermined condition is satisfied for use of the plurality of services, provide a break in the reservation between one service out of the plurality of services and another service out of the plurality of services with the use time frame of the other service arranged in sequence with the use time frame of the one service.
   (((6)))

The information processing system according to any one of (((1))) to (((5))), wherein the one or more processors are configured to:
present, to the client, candidates for the combination of the plurality of services with the use time frames not overlapping each other based on the business operator information; and
make a collective reservation for the plurality of identified services based on the candidate selected by the client among the presented candidates.
   (((7)))

The information processing system according to (((6))), wherein the one or more processors are configured to:
if the business operator information includes information indicating priority levels assigned to the plurality of services for extraction of collectively reserved services, present the candidates to the client based on the priority levels.

(((8)))

The information processing system according to (((7))), wherein the one or more processors are configured to:
assign the priority levels to the plurality of services based on at least one of a sequence, usage counts, or evaluations of the services in the combination expected to achieve the purpose.
   (((9)))

The information processing system according to any one of (((1))) to (((8))), wherein the one or more processors are configured to:
if the client information includes information indicating a desired time frame for use of the plurality of services by the client, make a collective reservation for the combination of the plurality of services with the use time frames not overlapping each other within the desired time frame.
   (((10)))

The information processing system according to any one of (((1))) to (((9))), wherein the one or more processors are configured to:
if the client information includes information indicating a condition set by the client about details of the plurality of services, make a collective reservation for the plurality of identified services that satisfy the condition.
   (((11)))

The information processing system according to any one of (((1))) to (((10))), wherein the one or more processors are configured to:
if the plurality of identified services are provided by the business operators different from each other, make a collective reservation for a combination of the plurality of business operators with the use time frames not overlapping each other.
   (((12)))

The information processing system according to (((11))), wherein the one or more processors are configured to:
if the plurality of business operators are in different businesses, make a collective reservation for the combination of the plurality of business operators with the use time frames not overlapping each other in a sequence in which the purpose is achievable based on details of the businesses.
   (((13)))

The information processing system according to any one of (((1))) to (((8))), wherein the one or more processors are configured to:
cause a display to display an operation image for receiving an operation of specifying the purpose from the client; and
cause the display to display a selection image for receiving, from the client, an operation of selecting the use time frames from reservable time frames of the combination of the plurality of services associated with the purpose.
   (((14)))

The information processing system according to any one of (((1))) to (((13))), wherein the one or more processors are configured to:
present new combinations of the plurality of services in response to cancellation of reservation for one service in the reserved combination of the plurality of services by the business operator that provides the one service; and make a collective reservation again for the plurality of services based on the new combination selected by the client among the presented new combinations.
   (((15)))

The information processing system according to (((14))), wherein the one or more processors are configured to:
present the new combinations with the one service replaced by another service equivalent to the one service and provided by another business operator different from the business operators.
   (((16)))

The information processing system according to (((14))), wherein the one or more processors are configured to:
present the new combinations changed in terms of a sequence of the plurality of services in the reserved combination.
   (((17)))

The information processing system according to (((14))), wherein the one or more processors are configured to:
present the new combinations so that the use time frame of the reserved service subsequent to the one service out of the plurality of services excluding the one service in the reserved combination is made earlier.
   (((18)))

The information processing system according to any one of (((1))) to (((13))), wherein the one or more processors are configured to:
in response to cancellation of reservation for one service out of the plurality of collectively reserved services by one business operator that provides the one service, notify other business operators in the same business as the one business operator about a call for a service reservable within the use time frame of the one service in the reservation; and
make a reservation for another service provided by any one of the notified other business operators responding to the call in the use time frame of the one service in the reservation.
   (((19)))

A program causing a computer to execute a process comprising:
acquiring, from a client expected to use a plurality of reservable services in combination, client information including a purpose of the client;
identifying the plurality of services associated with the purpose in the client information;
acquiring business operator information on business operators that provide the plurality of identified services, the business operator information including schedules of the business operators; and
making a collective reservation for a combination of the plurality of identified services with use time frames of the plurality of services not overlapping each other based on the business operator information.

What is claimed is:

1. An information processing system comprising:
one or more processors configured to:
acquire, from a client expected to use a plurality of reservable services in combination, client information including a purpose of the client;
identify the plurality of services associated with the purpose in the client information;
acquire business operator information on business operators that provide the plurality of identified services, the business operator information including schedules of the business operators; and
make a collective reservation for a combination of the plurality of identified services with use time frames of the plurality of services not overlapping each other based on the business operator information.

2. The information processing system according to claim 1, wherein the one or more processors are configured to:
if the client information includes information indicating a rental place for use of the plurality of identified services, acquire place information on a schedule of the place; and
make a collective reservation for the place and the combination of the plurality of services with the use time frames not overlapping each other within a reservable time frame of the place based on the business operator information and the place information.

3. The information processing system according to claim 2, wherein the one or more processors are configured to:
if a terminal apparatus is used for the use of the plurality of services, make a collective reservation for the place where the terminal apparatus is disposed and the combination of the plurality of services with the use time frames not overlapping each other within the reservable time frame of the place.

4. The information processing system according to claim 1, wherein the one or more processors are configured to:
if the business operator information includes information indicating expected periods of the plurality of services provided by the business operators, make a collective reservation for the combination of the plurality of identified services with the use time frames arranged in sequence.

5. The information processing system according to claim 4, wherein the one or more processors are configured to:
if a predetermined condition is satisfied for use of the plurality of services, provide a break in the reservation between one service out of the plurality of services and another service out of the plurality of services with the use time frame of the other service arranged in sequence with the use time frame of the one service.

6. The information processing system according to claim 1, wherein the one or more processors are configured to:
present, to the client, candidates for the combination of the plurality of services with the use time frames not overlapping each other based on the business operator information; and
make a collective reservation for the plurality of identified services based on the candidate selected by the client among the presented candidates.

7. The information processing system according to claim 6, wherein the one or more processors are configured to:
if the business operator information includes information indicating priority levels assigned to the plurality of services for extraction of collectively reserved services, present the candidates to the client based on the priority levels.

8. The information processing system according to claim 7, wherein the one or more processors are configured to:
assign the priority levels to the plurality of services based on at least one of a sequence, usage counts, or evaluations of the services in the combination expected to achieve the purpose.

9. The information processing system according to claim 1, wherein the one or more processors are configured to:
if the client information includes information indicating a desired time frame for use of the plurality of services by the client, make a collective reservation for the combination of the plurality of services with the use time frames not overlapping each other within the desired time frame.

10. The information processing system according to claim 1, wherein the one or more processors are configured to:
if the client information includes information indicating a condition set by the client about details of the plurality of services, make a collective reservation for the plurality of identified services that satisfy the condition.

11. The information processing system according to claim 1, wherein the one or more processors are configured to:
if the plurality of identified services are provided by the business operators different from each other, make a collective reservation for a combination of the plurality of business operators with the use time frames not overlapping each other.

12. The information processing system according to claim 11, wherein the one or more processors are configured to:
if the plurality of business operators are in different businesses, make a collective reservation for the combination of the plurality of business operators with the use time frames not overlapping each other in a sequence in which the purpose is achievable based on details of the businesses.

13. The information processing system according to claim 1, wherein the one or more processors are configured to:
cause a display to display an operation image for receiving an operation of specifying the purpose from the client; and
cause the display to display a selection image for receiving, from the client, an operation of selecting the use time frames from reservable time frames of the combination of the plurality of services associated with the purpose.

14. The information processing system according to claim 1, wherein the one or more processors are configured to:
present new combinations of the plurality of services in response to cancellation of reservation for one service in the reserved combination of the plurality of services by the business operator that provides the one service; and
make a collective reservation again for the plurality of services based on the new combination selected by the client among the presented new combinations.

15. The information processing system according to claim 14, wherein the one or more processors are configured to:
present the new combinations with the one service replaced by another service equivalent to the one service and provided by another business operator different from the business operators.

16. The information processing system according to claim 14, wherein the one or more processors are configured to:
present the new combinations changed in terms of a sequence of the plurality of services in the reserved combination.

17. The information processing system according to claim 14, wherein the one or more processors are configured to:
present the new combinations so that the use time frame of the reserved service subsequent to the one service out of the plurality of services excluding the one service in the reserved combination is made earlier.

18. The information processing system according to claim 1, wherein the one or more processors are configured to:
in response to cancellation of reservation for one service out of the plurality of collectively reserved services by one business operator that provides the one service, notify other business operators in the same business as the one business operator about a call for a service reservable within the use time frame of the one service in the reservation; and
make a reservation for another service provided by any one of the notified other business operators responding to the call in the use time frame of the one service in the reservation.

19. A non-transitory computer readable medium storing a program causing a computer to execute a process comprising:
acquiring, from a client expected to use a plurality of reservable services in combination, client information including a purpose of the client;
identifying the plurality of services associated with the purpose in the client information;
acquiring business operator information on business operators that provide the plurality of identified services, the business operator information including schedules of the business operators; and
making a collective reservation for a combination of the plurality of identified services with use time frames of the plurality of services not overlapping each other based on the business operator information.

20. An information processing method comprising:
acquiring, from a client expected to use a plurality of reservable services in combination, client information including a purpose of the client;
identifying the plurality of services associated with the purpose in the client information;
acquiring business operator information on business operators that provide the plurality of identified services, the business operator information including schedules of the business operators; and
making a collective reservation for a combination of the plurality of identified services with use time frames of the plurality of services not overlapping each other based on the business operator information.
